(19) United States
(12) Patent Application Publication
(10) Pub. No.: US 2010/0153370 A1
(43) Pub. Date: Jun. 17, 2010

(54) SYSTEM OF RANKING SEARCH RESULTS BASED ON QUERY SPECIFIC POSITION BIAS

(75) Inventors: Sreenivas Gollapudi, Cupertino, CA (US); Rina Panigrahy, Sunnyvale, CA (US)

Correspondence Address: VIERRA MAGEN/MICROSOFT CORPORATION, 575 MARKET STREET, SUITE 2500, SAN FRANCISCO, CA, 94105, US

(73) Assignee: MICROSOFT CORPORATION, Redmond, WA (US)

(21) Appl. No.: 12/335,396

(22) Filed: Dec. 15, 2008

(51) Int. Cl. G06F 17/30

(52) U.S. Cl. 707/722; 707/E17.017; 707/E17.014; 707/E17.109; 707/E17.108; 707/E17.116

(57) ABSTRACT

A model based on a generalization of the Examination Hypothesis is disclosed that states that for a given query, the user click probability on a document in a given position is proportional to the relevance of the document and a query specific position bias. Based on this model the relevance and position bias parameters are learned for different queries and documents. This is done by translating the model into a system of linear equations that can be solved to obtain the best fit relevance and position bias values. A cumulative analysis of the position bias curves may be performed for different queries to understand the nature of these curves for navigational and informational queries. In particular, the position bias parameter values may be computed for a large number of queries. Such an exercise reveals whether the query is informational or navigational. A method is also proposed to solve the problem of dealing with sparse click data by inferring the goodness of unclicked documents for a given query from the clicks associated with similar queries.

### BACKGROUND

Search engines are a powerful tool for sifting through vast amounts of stored information in a structured and discriminating scheme. Popular search engines, such as that provided by the MSN® network of Internet services and others, service tens of millions of queries for information every day. A typical search engine for use in finding documents on the World Wide Web operates by a coordinated set of programs including a spider (also referred to as a “crawler” or “bot”) that gathers information from web pages on the World Wide Web in order to create entries for a search engine index, or log; an indexing program that creates the log from the web pages that have been read; and a search program that receives a search query, compares it to the entries in the log, and returns results appropriate to the search query.

Search engines return results in a ranked order, typically with the most relevant result displayed at a top position, and successively down to the least relevant result at the bottom of the list. Properly ranking results is important, for example when the results are advertisements. In order to maximize revenues, when a user performs a search, the search engine should position the most relevant advertisements at the top of the ranked results, thereby maximizing the probability that the advertisement will be clicked on and revenues will be generated.

The ranking of search results may be determined by a variety of criteria. In one model, query results are ranked according to historical logged data. In particular, the search engine stores past search queries, the results returned for the past search queries, and which results were clicked on. Results which have a high click-through rate (“CTR”) for a given search query may move to a higher ranking relative to other results with a lower CTR. In such an event, the next time the same query is entered into the search engine, the results are reordered to reflect the best estimate of relevance of the results.

However, CTR is not the sole determinant of document relevance to a given search query. Eye-tracking and other experiments have determined that there is a natural bias, referred to as position bias, to click on results that are at higher positions on the ranked list than results at the bottom. As results get ranked based on logged CTR, position bias needs to be factored in and corrected so that documents at the bottom positions of a search result which are seldom clicked may be evaluated for relevance against documents at the top positions of a search result, without position factoring into the evaluation. Once this analysis is performed, a determination may be made as to whether to move a given search result document up or down in the ranked result the next time the same search query is entered.

One model for correcting for position bias is the Examination Hypothesis proposed by Richardson, Dominowska and Ragno in their paper, “Predicting Clicks: Estimating the Click-Through Rate for new Ads,” WWW '07: Proceedings of the 16th international conference on World Wide Web, pp. 521-30 (2007), which publication is incorporated by reference herein in its entirety. This model proposes a curve representing the decay in the probability of clicking on a result the lower the result is in the ranked results. Of significance is that the curve proposed by the Examination Hypothesis is independent of the search query. It is based entirely on the position of the ranked result.

One problem with the Examination Hypothesis is that it has been found that different types of queries have different rates of decay with respect to the probability of clicking on a result at a given position. In the publication “Taxonomy of Web Search,” SIGIR Forum, 36(2):3-10 (2002), Broder classified queries into three main categories: informational, navigational, and transactional. An informational query is less of a targeted search and more of a search for information believed to exist on one or more web pages, but the user does not have a specific destination web page in mind. A navigational query, on the other hand, is more of a targeted search, issued with an immediate intent to reach a particular site. For example, the query “cnn” probably targets the site http://www.cnn.com and hence can be deemed navigational. In a navigation search, the user expects the desired result to be shown in one of the top positions in the result page. On the other hand, in an informational search, the user is more inclined to consider results including those in the lower positions on the page. This behavior would naturally result in a navigational query having a different click through rate curve under the Examination Hypothesis from an informational query. This suggests that the position bias is at some level dependent on the query.

### SUMMARY

The present system provides a model based on a generalization of the Examination Hypothesis that states that for a given query, the user click probability on a document in a given position is proportional to the relevance of the document and a query specific position bias. Based on this model, the relevance and position bias parameters are learned for different queries and documents. This is done by translating the model into a system of linear equations that can be solved to obtain the best fit relevance and position bias values. Experimental results show that the relevance measure is comparable to other well known ranking features like BM25F and PageRank using well known metrics like NDCG, MAP, and MRR.

In further embodiments, a cumulative analysis of the position bias curves may be performed for different queries to understand the nature of these curves for navigational and informational queries. In particular, the position bias parameter values may be computed for a large number of queries. Such an exercise reveals whether the query is informational or navigational. A method is also proposed to solve the problem of dealing with sparse click data by inferring the goodness (i.e., relevance) of unclicked documents for a given query from the clicks associated with similar queries.

### BRIEF DESCRIPTION OF THE DRAWINGS

FIG. 1 is a flowchart illustrating operation of embodiments of the present system.

FIG. 2 is a bipartite graph of search result documents and positions including disconnected components.

FIG. 3 is a bipartite graph of search result documents and positions including a single connected component.

FIGS. 4 and 5 are graphs showing the performance of the present system in determining goodness for ranking search results in comparison to other known methods.

FIGS. 6 and 7 are graphs showing goodness ratings of the present system at different search results ranking positions in comparison to other known methods.

FIG. 8 is a graph of a position bias curve obtained according to embodiments of the present system.

FIG. 9 is a best fit curve obtained from the position bias curve of FIG. 8.

FIG. 10 is a graph showing goodness ratings of the present system at different search results ranking positions upon combining disconnected components from a bipartite graph.

FIG. 11 is a graph showing goodness ratings of the present system obtained by inferring goodness from additional search queries in comparison to other known methods.

FIG. 12 is a block diagram of an embodiment of a computing environment for carrying out the present system.

### DETAILED DESCRIPTION

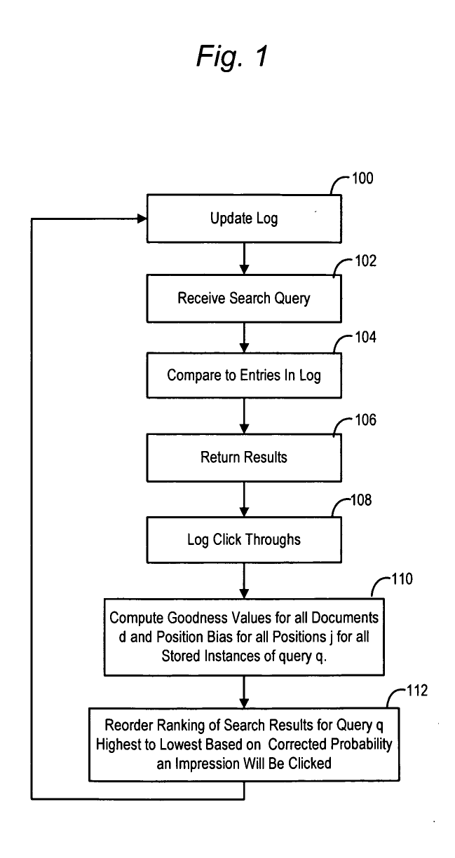

Embodiments of the present system will now be described with reference to FIGS. 1-12, which in general relate to a method of predicting click-through rate on search results using in part a position bias that is query dependent. The present system is based on the analysis of click logs of a commercial search engine, such as for example that provided by the MSN® network of Internet services and others. Such logs typically capture information like the most relevant results returned for a given query and the associated click information for a given set of returned results. Each entry in the log may include a query q, the top k (typically equal to 10) documents D, the ranked position j, and the clicked document d∈D. Referring initially to the flowchart of FIG. 1, in step 100, the entries in the log are updated. This may include the addition of newly found or added documents and advertisements that are appropriate to particular queries, and/or it may include the reordering of search results appropriate to particular queries in accordance with the present system as explained below.

In a step 102, the search engine may receive a search query. That query is compared against log entries in step 104, and the results are returned to the user in step 106. The search engine also logs click data, i.e., which results were clicked, in step 108. Such click data can be used to obtain the aggregate number of clicks a_{q}(d, j) on d in position j and the number of impressions of document d∈D in position j, denoted by m_{q}(d, j), by a simple aggregation over all logged records for the given query (including the clicks logged in step 108 and stored instances of past clicks for result of that same query). The ratio a_{q}(d, j)/m_{q}(d, j) gives the click through rate of document d in position j.

The Examination Hypothesis for advertisements proposed in the above-incorporated publication by Richardson et al. states that there is a position dependent probability of examining a result. In general, this hypothesis states that for a given query q, the probability of clicking on a document d in position j is dependent on the probability, e_{q}(d, j), of examining the document in the given position and the relevance, g_{q}(d), of the document to the given query. It can be stated as:

c_{q}(d, j)=e_{q}(d, j)g_{q}(d), (1)

where c_{q}(d, j) is the probability that an impression of document d at position j is clicked. Alternately, it can also be viewed as the click through rate on a document d in position j. Thus, c_{q}(d, j) can be estimated from the click logs as c_{q}(d, j)=a_{q}(d, j)/m_{q}(d, j). Position bias, p_{q}(d, j), may be defined as the ratio of the probability of examining a document in position j to the probability of examining the document at position 1. That is, for a given query q, the position bias for a document d at position j is defined as p_{q}(d, j)=e_{q}(d, j)/e_{q}(d, 1).

The above-described term for relevance, g_{q}(d), also referred to herein as goodness, is defined to be the probability that document d is clicked when shown in position 1 for query q, i.e., g_{q}(d)=c_{q}(d, 1). In embodiments, goodness may be a measure of the relevance of the search result snippet (i.e., the words or phrases returned by the search engine to describe a found document) rather than the relevance of the document d itself. It is understood that the concept of goodness may be expanded in alternative embodiments to combine click through information with other user behavior, such as dwell time, to capture the relevance of the document. The above definition of goodness removes the effect of the position from the CTR of a document (snippet) and reflects the true relevance of a document that is independent of the position at which it is shown.

In accordance with the present system, the position bias, p_{q}(d, j), depends only on the position j and query q and is independent of the document d. Accordingly, the dependence on d is dropped from the notation of position bias, and the bias at position j is denoted as p_{q}(j). The position bias at the first position is defined as 1: p_{q}(1)=1. Each entry in the query log will give the equation for the probability that an impression of document d at position j is clicked:

c_{q}(d, j)=g_{q}(d)p_{q}(j) (2)

For a fixed query q, the q notation may be implicitly dropped from the subscript for convenience so that equation (2) may be written: c(d, j)=g(d)p(j).

Prior art click probability models are known which are based on the product of relevance and position bias. However, the position bias parameter p(j) in the present system is allowed to depend on the query, whereas earlier works assumed the position bias to be global constants independent of the query.

In step 110, the present system computes goodness values g(d) and position biases p(j) for all stored instances of query q. In particular, the different document/position pairs in the click log associated with a given query give a system of equations c(d, j)=g(d)p(j) that can be used to learn the latent variables g(d) and p(j). The number of variables in this system of equations is equal to the number of distinct documents, for example m, plus the number of distinct positions, for example n. This system of equations may be solved for the variables as long as the number of equations is at least the number of variables.

The log may include different stored instances of the same search query q, and the stored document results D may be different for the different search instances. New documents may have been added since the prior search of the same query, and respective documents d may have moved up or down in the ranked results (step 100). Therefore, the number of equations may be more than the number of variables in which case the system is over constrained. In such a case, g(d) and p(j) may be solved for in such a way that best fit the equations so as to minimize the cumulative error between the left and the right side of the equations, using some kind of a norm. One method to measure the error in the fit is to use the L₂-norm, i.e., ∥c(d, j)=log g(d)p(j)∥₂. However, instead of looking at the absolute difference as stated above, it is appropriate to look at the percentage difference since the difference between CTR values of 0.4 and 0.5 is not the same as the difference between 0.001 and 0.1001. As such, the basic equation stated as Equation (2) can be modified as:

log c(d, j)=log g(d)+log p(j). (3)

Log g(d), log p(j), log c(d, j) by ĝ_{d}, \hat{p}ⱼ, and ĉ_{dj}, respectively. Let ε denote the set of all query, document and position combinations in click log. This results in the following system of equations over the set of entries E_{q}∈ε in the click log for a given query.

∀(d, j)∈E_{q}ĝ_{d}+\hat{p}ⱼ=ĉ_{dj} (4)

\hat{p}₁=0 (5)

This may be written in matrix notation Ax=b, where x=(ĝ₁, ĝ₂ . . . ĝₘ, \hat{p}₁, \hat{p}₂, . . . , \hat{p}ₙ) represents the goodness values of the m documents and the position biases at all the n positions. The best fit solution x may be solved for that minimizes ∥AX−b∥₂=\hat{p}₁²+Σ_{(d, j)∈E}_{_{q}}(ĝ_{d}+\hat{p}ⱼ−ĉ_{dj})². The solution is given by x=(A′A)⁻¹ A′b.

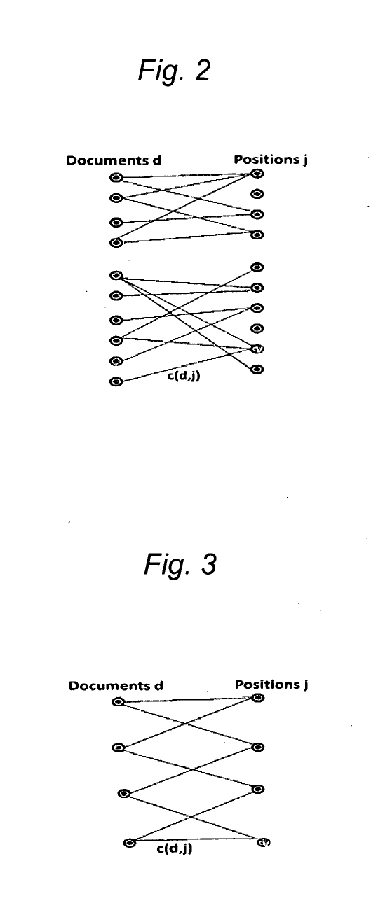

Finding the best fit solution x requires that A′A be invertible. To understand when A′A is invertible, for a given query, reference is made to the bipartite graph B shown in FIG. 2. The bipartite graph B shows the m documents d on the left side and the n positions j on the right side, and includes an edge if the document d has appeared in position j. If there is an edge, this means that there is an equation corresponding to ĝ_{d} and \hat{p}ⱼ in Equation (4). Essentially, ĝ_{d} and \hat{p}ⱼ values are being deduced by looking at paths in this bipartite graph that connect different positions and documents. But if the graph is disconnected, documents or positions in different connected components cannot be compared. If this graph is disconnected then A′A is not invertible and vice versa.

As a proof that A′A is invertible if and only if the underlying graph B is connected, if the graph is connected, A is full rank. This is because, since \hat{p}ⱼ=1, all ĝ_{d} for all documents can be solved for that are adjacent to position 1 in graph B. Further, whenever there is a known value for a node, the values of all its neighbors in B can be derived. Since the graph is connected, every node is reachable from position 1. So A has full rank implying that A′A is full ranked and therefore invertible.

If the graph is disconnected, consider any component which does not contain position 1. It may be argued that the system of equations for this component is not full rank. This is Ax=Ax′ for a solution vector x with certain ĝ_{d} and \hat{p}ⱼ values for nodes in the component, and the solution vector x′ with values ĝ_{d}−α and \hat{p}ⱼ+α, for any α. Therefore, A is not full rank as there can be many solutions with the same left hand side, implying A′A is not invertible.

Even if the bipartite graph B is disconnected, the system of equations set forth above may still be used to compare the goodness and position bias values within one connected component. This is achieved by measuring position bias values relative to the highest position within the component instead of position 1. Consider for example a connected component not containing position 1, with documents d₁, d₂, . . . , dₖ and positions j₁, j₂, . . . , jₖ in increasing order. From the above argument, it is clear that if the submatrix M of A corresponding to only this component is considered, M′M is invertible. Further, given a solution vector x=(ĝ_{d}_{₁}, . . . , \hat{d}_{d}_{ₖ}, \hat{p}ⱼ_{₁}, . . . , \hat{p}ⱼ_{₁}), then the vector x′=(ĝ_{d}_{₁}−α, ĝ_{d}_{₂}−α, . . . , ĝ_{d}_{ₖ}−α, \hat{p}ⱼ_{₁}+α, . . . , \hat{p}ⱼ_{₂}+α, . . . , \hat{p}ⱼ_{₁}+α) is an equivalent solution in the sense that Mx=Mx′. Hence, ∥Mx−b∥₂=∥Mx′−b∥₂.

One method to make M′M invertible is to peg the position bias of the highest position in the component at 1 by adding the equation \hat{p}ⱼ_{₁}=0 (since \hat{p}ⱼ_{₁}=log(j₁)). This amounts to comparing all position biases within the component relative to the position j₁ instead of position 1. As such, each connected component may be handled separately and the ĝ_{d}, \hat{p}ⱼ variables may be solved for in each component. While these values can be meaningfully compared within a component, it does not make sense to compare them across components. A method for combining connected components is described below.

The present system is based in part on the hypothesis, referred to herein as the Document Independence Hypothesis, that position bias, p_{q}(d, j), is based on document position j and the query q, and is independent of the document d. This may be proven with reference to logged click data and the bipartite graphs of FIGS. 2 and 3. As discussed above, FIG. 2 shows a bipartite graph for a query with documents on one side and positions on the other, with each edge (d, j) labeled ĉ_{dj}. Cycles in this graph must satisfy a special property, as will be explained below with reference to the bipartite graph of FIG. 3.

For each edge (d, j) in the graph of FIG. 3, there is a c(d, j) obtained from the query log. Let C=(d₁, j₁, d₂, j₂, d₃, . . . , dₖ, jₖ, d₁) denote a cycle in this graph with alternating edges between documents d₁, d₂, . . . , dₖ and positions j₁, j₂, . . . , jₖ and connecting back at node d₁. As shown below, the Document Independence Hypothesis implies that the sum of the ĉ_{dj} values (ĉ_{dj}=log c(d, j)) on odd and even edges on the cycle are equal. This provides a test for the Document Independence Hypothesis by computing the sum for different cycles.

In particular, given a cycle C=(d₁, j₁, d₂, j₂, d₃, . . . , dₖ, jₖ, d₁), the Document Independence Hypothesis implies that sum (C)=Σᵢ₌₁^{k}ĉ_{d}_{ᵢ}ⱼ_{ᵢ}−Σᵢ₌₁^{k}ĉ_{d}_{ᵢ₊₁}ⱼ_{ᵢ}=0 (where dₖ₊₁ is the same as d₁ for convenience). In order to prove this, it needs to be shown that Σᵢ₌₁^{k}ĉ_{d}_{ᵢ}ⱼ_{ᵢ}=Σᵢ₌₁^{k}ĉ_{d}_{ᵢ₊₁}ⱼ_{ᵢ}. As ĉ_{dj}=ĝ_{d}+\hat{p}ⱼ, this implies that Σᵢ₌₁^{k}ĉ_{d}_{ᵢ}ⱼ_{ᵢ}=Σᵢ₌₁^{k}ĝ_{d}_{ᵢ}+\hat{p}ⱼ_{ᵢ}. Similarly Σᵢ₌₁^{k}ĉ_{d}_{ᵢ₊₁}ⱼ_{ᵢ}=Σᵢ₌₁^{k}ĝ_{d}_{ᵢ₊₁}+\hat{p}ⱼ_{ᵢ}=Σᵢ₌₁^{k}ĝ_{d}_{ᵢ}+\hat{p}ⱼ_{ᵢ} (since dₖ₊₁=d₁).

In practice, it is not expected that the sum(C) will be exactly 0. Longer cycles are likely to have a larger error from 0. To normalize this, take the

$$ratio ( C ) = \frac{sum ( C )}{\sqrt{{\sum }_{i = 1}^{k} {\vert {\hat{c}}_{{d}_{i} {j}_{i}} \vert}^{2} + {\sum }_{i = 1}^{k} {\vert {\hat{c}}_{{d}_{i + 1} {j}_{i}} \vert}^{2}}} .$$

The denominator is essentially ∥C∥₂ where C is viewed as a vector of ĉ_{dj} values associated with the edges in the cycle. The number of dimensions of the vector is equal to the length of the cycle. Thus, ratio(C)=sum(C)/∥C∥₂ is simply normalizing sum(C) by the length of the vector C. It can be shown theoretically that for a random vector C of length ∥C∥₂ in a high dimensional Euclidean space, the root mean squared value of |ratio(C)|=|sum(C)|/∥C∥₂ is equal to 1. Thus, a value of |ratio(C)| much smaller than 1 indicates that |sum(C)| is biased towards smaller values. This provides a method to test the validity of the Document Independence Hypothesis by measuring |sum(C)| and |ratio(C)| for different cycles C.

Once goodness values g(d) and position biases p(j) have been calculated, the likelihood of selecting a particular document may be calculated according to the general equation c(d, j)=g(d)p(j), which is solved for as described above for the various documents associated in the log with a given query. Using this result, the search results for a given query q may be reordered in the log in step 112 from highest (most relevant) to lowest (least relevant) for the search query, and the log may be updated in step 100. Thereafter, the next instance of the search q will result in the updated search results.

### EXAMPLE 1

This Example analyzes the relevance and position bias values obtained by running the algorithm of the present system on a commercial search engine click data. Specifically, the relevance and position bias values are validated by adopting the goodness as a standalone ranking feature, as in the link-based PageRank discussed in the publication, S. Brin and L. Page, “The Anatomy of a Large-Scale Hypertextual Web Search Engine,” Computer Networks, 30(1-7):107-117 (1998), and textual-based BM25F discussed in the publication, H. Zaragoza, N. Craswell, M. Taylor, S. Saria, and S. Robertson, “Microsoft Cambridge at TREC-13: Web and Hard Tracks,” TREC, pages 418-425 (2004). Both of these publications are incorporated by reference herein in their entirety.

This Example uses click data from a click log containing queries with frequencies between 1,000 and 100,000 over a period of one month. Only entries in the log were considered where the number of impressions for a document in a top-10 position is at least 100, and the number of clicks is non-zero. The truncation is done in order to ensure the c_{q}(d, j) is a reasonable estimate of the click probability. The above filtering resulted in a click log, Q, containing 2.03 million entries with 128,211 unique queries and 1.3 million distinct documents.

The effectiveness of the algorithm was measured by comparing the ranking produced when ordering documents for query based on the relevance values to human judgments. The effectiveness of the ranking algorithm is quantified using three well known measures: NDCG, MRR, and MAP. These measures are explained for example in the above-incorporated publication to Zaragoza et al. Each of these measures can be computed at different rank thresholds T and are specified by NDCG@T, MAP@T, and MRR@T. In this study, T was set equal to 1, 3 and 10.

The normalized discounted cumulative gains (NDCG) measure discounts the contribution of a document to the overall score as the document's rank increases (assuming that the most relevant document has the lowest rank). Higher NDCG values correspond to better correlation with human judgments. Given a ranked result set Q, the NDCG at a particular rank threshold k is defined as:

$$N D C G ( Q , k ) = \frac{1}{\vert Q \vert} {\sum }_{j = 1}^{\vert Q \vert} {Z}_{k} {\sum }_{m = 1}^{k} \frac{{2}^{r ( j )} - 1}{log ( 1 + j )} ,$$

where r(j) is the(human judged) rating (0=bad, 2=fair, 3=good, 4=excellent, and 5=definitive) at rank j and Zₖ is the normalization factor calculated to make the perfect ranking at k have an NDCG value of 1.

The reciprocal rank (RR) is the inverse of the position of the first relevant document in the ordering. In the presence of a rank-threshold T, this value is 0 if there is no relevant document in positions below this threshold. The mean reciprocal rank (MRR) of a query set is the average reciprocal rank of all queries in the query set.

The average precision of a set of documents is defined as

$$\frac{{\sum }_{i = 1}^{n} Relevance ( i ) / i}{{\sum }_{i = 1}^{n} Relevance ( i )} ,$$

where i is the position of the documents in the range, and Relevance(i) denotes the relevance of the document in position i. Typically, a binary value may be used for Relevance(i) by setting it to 1 if the document in position i has a human rating of fair or more and 0 otherwise. The mean average precision (MAP) of a query set is the mean of the average precisions of all queries in the query set.

One way to test the efficacy of a feature is to measure the effectiveness of the ordering produced by using the feature as a ranking function. This is done by computing the resulting NDCG of the ordering and comparing with the NDCG values of other ranking features. Two commonly used ranking features in search engines are BM25F and PageRank, discussed in the above-incorporated publications to Brin et al. and Zaragoza et al. In general, BM25F is a content-based feature while PageRank is a link based ranking feature. BM25F is a variant of BM25 that combines the different textual fields of a document, namely, title, body and anchor text. This model has been shown to be a strong-performing web search scoring function over the last few years. To get a control run, a random ordering of the result set is also included as a ranking and the performance of the three ranking features is compared with the control run.

In order to compute the values of relevance and position bias in the Example, the algorithm is run on the largest connected component for each query. Note that this limits the set of documents to those that exist in the largest connected component. To measure the effectiveness of the algorithm, the NDCG, MAP, and MRR scores of the ranking were computed based on the computed goodness values. The ranking based on goodness is referred to hereinafter as “Goodness.” Goodness was compared with other isolated features like BM25F, PageRank, and a random ordering. These features are referred to as BM25F, PageRank, and Random, respectively. The results with the ranking were computed based on raw click through ignoring position bias. This essentially results in a relevance score for a document that is proportional to the aggregate click through rate of the document over all positions; this ranking is referred to as “Clicks.” Finally, the results were compared with the model based on Examination Hypothesis without query dependence. This ranking is referred to as “Qind-exhyp.”

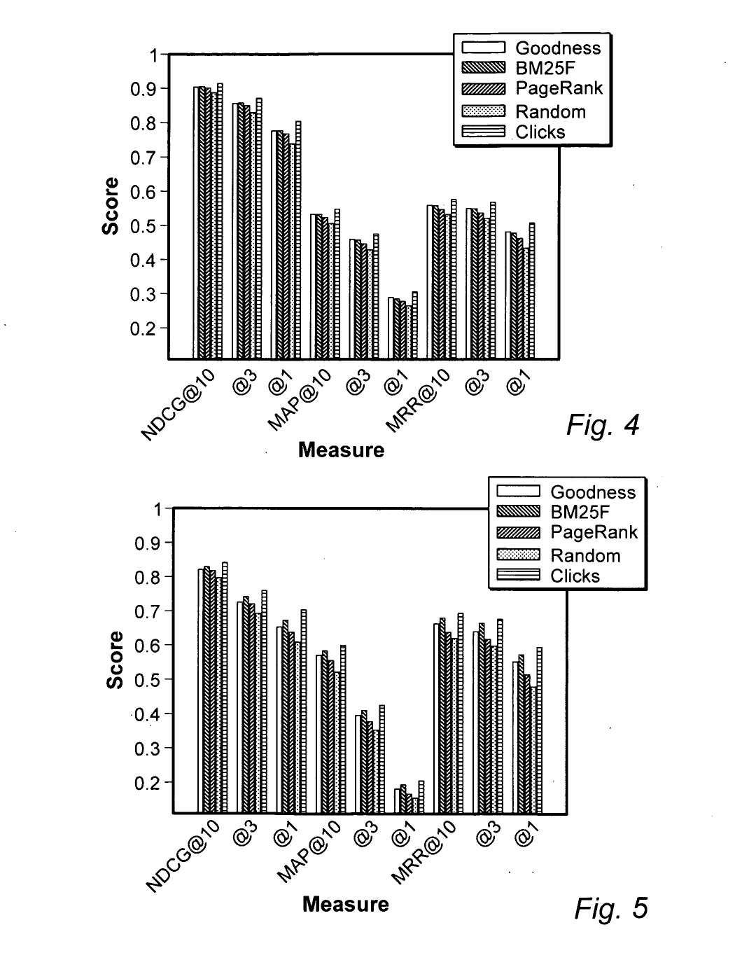

The scores were computed using two data sets: first, with the largest component for all queries in Q; and second for those queries whose largest component includes all positions 1 through 10 (there are cases where the bipartite graph B is a fully connected component). The first dataset is referred to as LC and the second dataset as LC10. The LC dataset has 775,854 entries with 118,915 distinct queries and 334,706 unique documents. The number of judged entries in the set was 22,685. For the second dataset, LC10, the number of entries was 112,735 with 2,614 unique queries and 42,119 unique documents. The number of judged entries was 6,148. FIGS. 4 and 5 show the NDCG, MAP, and MRR at rank thresholds 1, 3, and 10 for the two datasets.

As FIGS. 4 and 5 illustrate, most of the NDCG scores lie in a very small range. This is because this example involves a biased set of entries where most of the documents are shown in the top 10 positions and hence are highly relevant to begin with. This results in similar judgment ratings for these documents. In spite of the closeness, a consistent trend of relative scores is observed across the different features. A dataset that produces scores with a wider range is set forth below. As expected, BM25F outperforms PageRank and Random. Goodness lies between BM25F and PageRank.

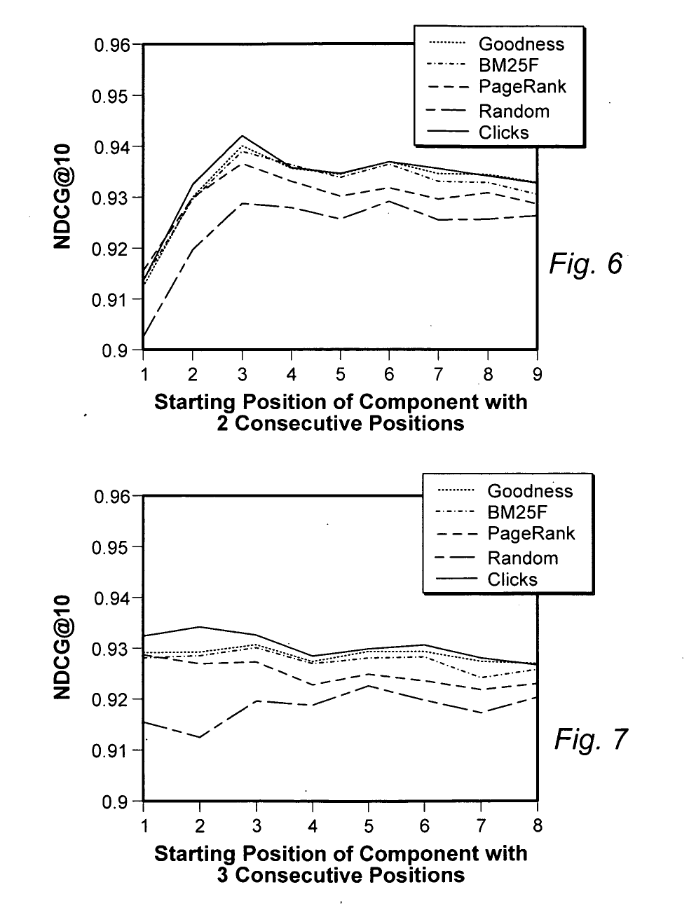

A set of experiments was also run on connected components over a smaller range of positions. Specifically, consecutive positions of length 2 and 3 were examined and the NDCG@10 scores over all such small components are shown in FIGS. 6 and 7. FIGS. 6 and 7 show the relative performance of each feature for the small components. Observe that Clicks continues to outperform Goodness at higher positions while Goodness does better than Clicks at lower positions.

The position bias vectors derived for fully connected components in LC10 may be used to study the trend of the position bias curves over different queries. A navigational query will have small p(j) values for the lower positions and hence \hat{p}ⱼ(log p(j)) that are large in magnitude. An informational query on the other hand will have \hat{p}ⱼ values that are smaller in magnitude. For a given position bias vector p, the entropy is given by

$$H ( p ) = - {\sum }_{j = 1}^{10} \frac{p ( j )}{\vert p \vert} log \frac{p ( j )}{\vert p \vert} .$$

The entropy is likely to be low for navigational queries and high for informational queries. The distribution of H(p) was measured over all the 2500 queries in LC10 and these queries were divided into ten categories of 250 queries each, obtained by sorting the H(p) values in increasing order.

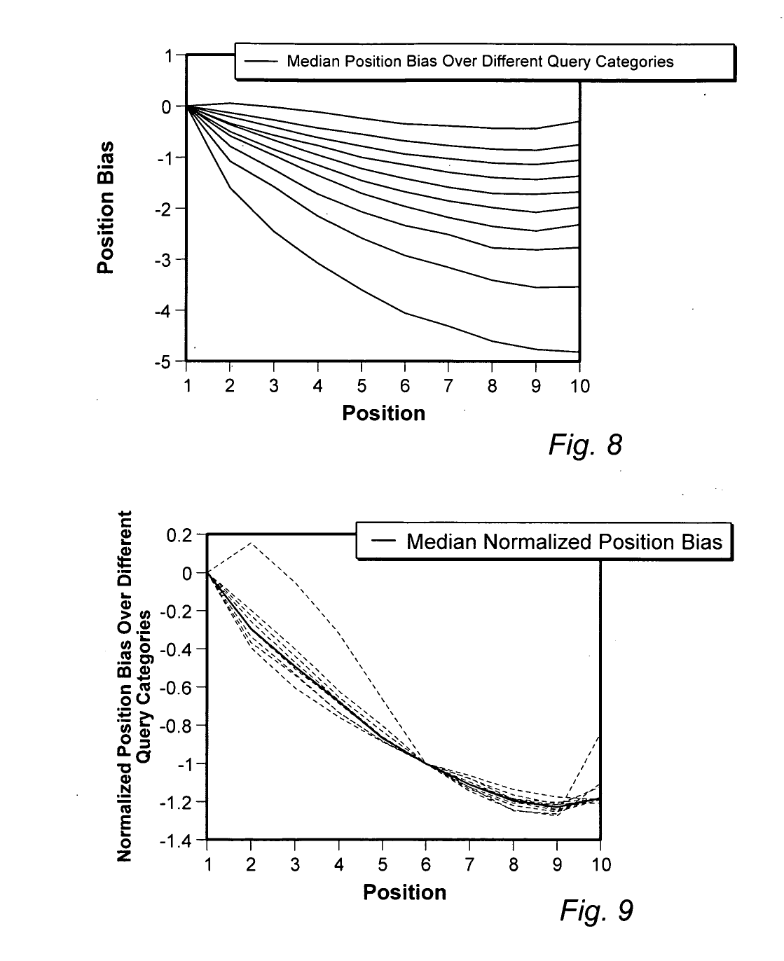

The aggregate behavior of the position bias curves within each of the ten categories will be explained with reference to FIG. 8. FIG. 8 shows the median value \hat{m}p of the position bias \hat{p} curves taken over each position over all queries in each category. The median curves in the different categories have more or less the same shape but different scale. All of these curves may be described as a single parameterized curve. To this end, each curve may be scaled so that the median log position bias \hat{m}p₆ at the middle position 6 is set to −1. Essentially, this computes normalized (\hat{m}ₚ)=−\hat{m}p₆. The normalized (\hat{m}p) curves over the ten categories are shown in FIG. 9. From this figure it is apparent that the median position bias curves in the ten categories are approximately scaled versions of each other (except for the one in the first category). The different curves in FIG. 9 can be approximated by a single curve by taking their median; this reads out to the vector Δ=(0, −0.2952, −0.4935, −0.6792, −0.8673, −1.0000, −1.1100, −1.1939, −1.2284, −1.1818). The aggregate position bias curves in the different categories can be approximated by the parameterized curve αΔ.

Such a parameterized curve can be used to approximate the position bias vector for any query. The value of α determines the extent to which the query is navigational or informational. Thus, the value of α obtained by computing the best fit parameter value that approximates the position bias curve for a query can be used to classify the query as informational or navigational. Given a position bias vector \hat{p}, the best fit of the value of α is obtained by minimizing ∥\hat{p}−αΔ∥₂, which results in α=Δ′\hat{p}/Δ′Δ. Table 1 shows some of the queries in LC10 with the high and low values of e^{-α}. The value of e^{-α} corresponds to position bias (since p(6)=e^{\hat{p}6}) at position 6 as per parameterized curve αΔ.

TABLE 1
e^{-α} for a sample queries.

| Query | e^{-α} |
|---|---|
| yahoofinance | 0.0001 |
| ziprealty | 0.0002 |
| tonight show | 0.0004 |
| winzip | 0.015 |
| types of snakes | 0.1265 |
| ram memory | 0.127 |
| writing desks | 0.2919 |
| sports injuries | 0.4250 |
| foreign exchange rates | 0.7907 |
| dental insurance | 0.7944 |
| sfo | 0.8614 |
| brain tumor symptoms | 0.9261 |

The algorithms described above produce goodness values that can be used to compare documents within each connected component. However, it does not enable comparing documents in different components. There are a number of queries where the size of the largest connected component is small. The algorithms described above may be extended to be able to combine the different connected components. To this end, the parameterized curve αΔ that approximates all position bias curves is used.

To simplify the description of the procedure, an extreme case of a query is presented where each document lies in its own connected component. An estimate ĉₑ can be obtained for its position bias curve by measuring the click through rate for the different positions, giving equal weight to each document (essentially assuming that all documents have equal goodness). Next the parameterized curve αΔ is used and the best fit value of the parameter is computed for the estimate \hat{p}ₑ. The value of c=αΔ is then substituted into Equations (4) and (5), and the best possible goodness values are computed. However, the computed value of α is discounted by a factor γ≦1 before using it in setting p=αΔ. This has the effect of making the position bias curve more informational. To illustrate the need for discounting, assume that the estimate \hat{p}ₑ already falls into the parameterized form. Note that without the discounting, substituting \hat{p}ₑ back into Equations (4) and (5) would simply result in equal goodness values for all documents. The ordering of the documents from that produced by the search engine should be altered only if there is a high confidence that documents shown on a lower position are better than those shown on a higher position. This is what the discounting achieves. By using a lower value of α, the goodness of the documents in the lower positions is decreased, thus ensuring that they will rise in goodness rank above a document in a higher position only if they are much better.

In the case where the documents do not all lie in different components, a better job of computing the estimate ĉₑ can be obtained. Goodness curves can be determined for each connected component; each curve is meaningful in itself but different curves cannot be compared as in principle the curves may be shifted up or down without affecting the relative values within a curve. Instead of simply assuming all documents to be of equal goodness, the goodness curves computed for the different connected components can be taken and shifted so that they are at about the same level. One method to achieve this is to add equations of the form w(ĝ_{d}−g)=0, where w is a small weighting constant, to the set of Equations (4) and (5), and g is a new variable. The matrix formulation Ax=b will now contain rows corresponding to these new equations. The objective function to be minimized ∥Ax−b∥₂=\hat{p}₁²+Σ_{(d,j)∈E}(ĝ_{d}+\hat{p}ⱼ−ĉ_{dj})²+Σ_{d}w²(ĝ_{d}−g)² is the same as before except that it contains the additional Σ_{d}w²(ĝ_{d}−g)². As w tends to 0, this will not change the relative values of the goodness curves within each connected component but simply shift them so as to make the goodness values across components as equal as possible.

In summary the algorithm for merging connected components is as follows.
Add the equations w(ĝ_{d}−g)=0 for all documents in the bipartite graph to the set of equations (4) and (5), where w is a small constant (e.g., set to 0.1) and g is a new variable. Write this in matrix form as Ax=b. x will now contain the new variable g in addition to ĝ_{d}'s and \hat{p}ⱼ's. Compute the best fit solution for the system of equations given by x=(A′A)⁻¹ A′b (A′A is now invertible because of the addition of the new equations). Let \hat{p}ₑ denote the position bias values in the best fit solution x.
Obtain the best fit parameter value that fits \hat{p}ₑ into the parameterized curve αΔ, given by α=\hat{p}ₑΔ/Δ′Δ.
Discount by a discount value γ. That is α=αγ.
Substitute p=αΔ back into the equations (4) and (5) to compute the best fit goodness values ĝ_{d}.

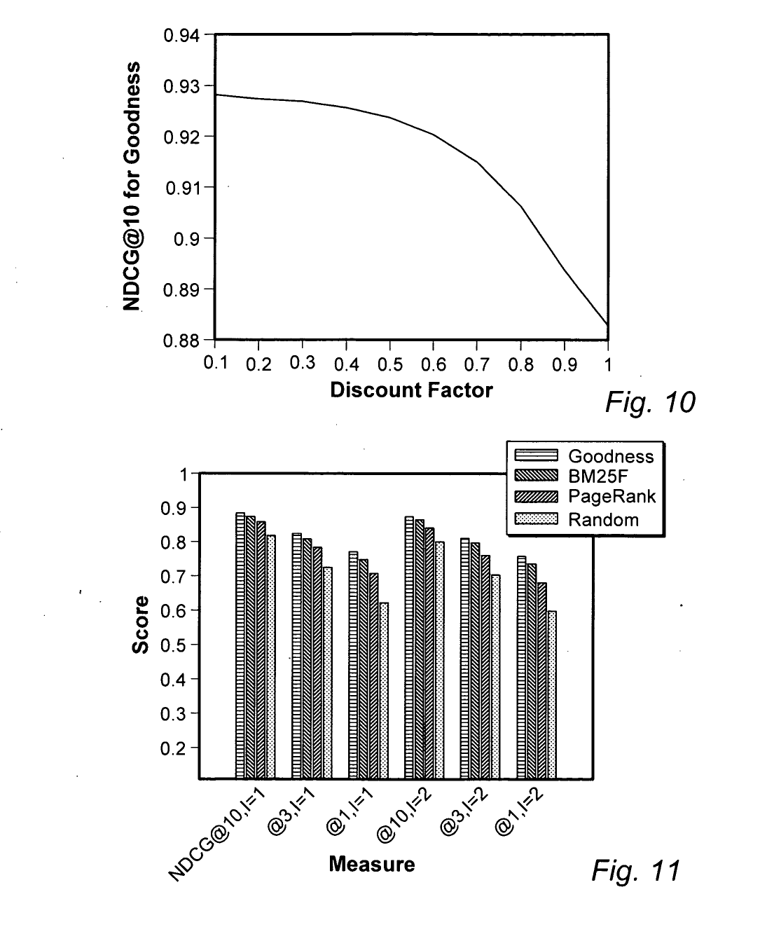

FIG. 10 shows the NDCG@10 score for this algorithm as a function of the discount factor γ. The NDCG@10 scores for Clicks, BM25F, PageRank, Random, and Qind-exhyp were 0.9284, 0.9169, 0.9112, 0.8734, and 0.9142 respectively. Observe that the NDCG of Goodness decreases as the discount factor decreases and approaches that of Clicks at γ=0.0. This is because at a discount factor of 0, the algorithm is the same as Clicks. Notice that at a value of γ=0.6, the NDCG@10 score for Goodness dominates BM25F.

One of the primary drawbacks of any click-based approach is the paucity of the underlying data as a large number of documents are never clicked for a query. Further embodiments of the present system may extend the goodness scores for a query to a larger set of documents. In this embodiment, it may be possible to infer the goodness of more documents for a query by looking at similar queries. Assuming there is access to a query similarity matrix S, it may be possible to infer new goodness values L_{dq} as:

$${L}_{dq} = {\sum }_{{q}^{′}} {S}_{{qq}^{′}} {G}_{{dq}^{′}} ,$$

where, S_{qq′} denotes the similarity between queries q and q′. This is essentially accumulating goodness values from similar queries by weighting them with their similarity values. Writing this in matrix form gives L=SG. The question then is how to obtain the similarity matrix S.

One method to compute S is to consider two queries to be similar if they share a lot of good documents. This can be obtained by taking the dot product of the goodness vectors spanning the documents for the two queries. This operation can be represented in matrix form as S=GG′. Another way to visualize this is to look at a complete bipartite graph with queries on the left and documents on the right with the goodness values on the edges of the graph. GG′ is obtained by first looking at all paths of length 2 between two queries and then adding up the product of the goodness values on the edges over all the 2-length paths between the queries.

A generalization of this similarity matrix is obtained by looking at paths of longer length, for example l, and adding up the product of the goodness values along such paths between two queries. This corresponds to the similarity matrix S=(GG′)^{l}. The new goodness values based on this similarity matrix is given by L=(GG′)^{l}G. Only non-zero entries in L are used as valid ratings.

The NDCG scores for this algorithm may then be computed, starting with the goodness matrix G obtained as described above with γ=0.6 containing 936606 non-zero entries. FIG. 11 shows the NDCG scores parameter l set to 1 and 2 respectively. The number of non-zero entries increases to over 7.1 million for l=1 and over 42 million for l=2. However, the number of judged query/document pairs only increases from 74781 for l=2 to 87235 for l=1. This implies that most of the documents added by extending to paths of length 2 are not judged results in the high value of NDCG scores for the Random ordering.

The present system provides a model based on a generalization of the Examination Hypothesis that states that for a given query, the user click probability on a document in a given position is proportional to the relevance of the document and a query specific position bias. Based on this model the relevance and position bias parameters are learned for different queries and documents. This is done by translating the model into a system of linear equations that can be solved to obtain the best fit relevance and position bias values. Experimental results show that the relevance measure is comparable to other well known ranking features like BM25F and PageRank using well known metrics like NDCG, MAP, and MRR.

Further, a cumulative analysis of the position bias curves was performed for different queries to understand the nature of these curves for navigational and informational queries. In particular, the position bias parameter values were computed for a large number of queries and it was found that the magnitude of the position bias parameter value indicates whether the query is informational or navigational. A method is also proposed to solve the problem of dealing with sparse click data by inferring the goodness of unclicked documents for a given query from the clicks associated with similar queries.

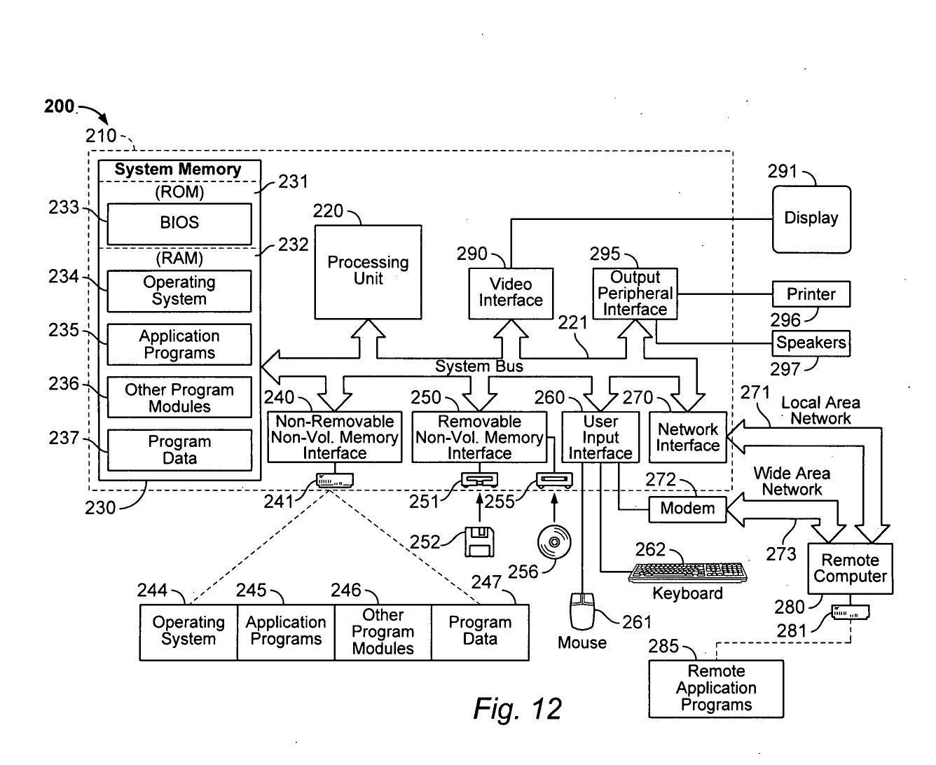

FIG. 12 shows a block diagram of a suitable general computing system 100 for performing the algorithms of the present system. The computing system 100 is only one example of a suitable computing environment and is not intended to suggest any limitation as to the scope of use or functionality of the present system. Neither should the computing system 100 be interpreted as having any dependency or requirement relating to any one or combination of components illustrated in the exemplary computing system 100.

The present system is operational with numerous other general purpose or special purpose computing systems, environments or configurations. Examples of well known computing systems, environments and/or configurations that may be suitable for use with the present system include, but are not limited to, personal computers, server computers, multiprocessor systems, microprocessor-based systems, network PCs, minicomputers, hand-held computing devices, mainframe computers, and other distributed computing environments that include any of the above systems or devices, and the like.

The present system may be described in the general context of computer-executable instructions, such as program modules, being executed by a computer. Generally, program modules include routines, programs, objects, components, data structures, etc., that perform particular tasks or implement particular abstract data types. In the distributed and parallel processing cluster of computing systems used to implement the present system, tasks are performed by remote processing devices that are linked through a communication network. In such a distributed computing environment, program modules may be located in both local and remote computer storage media including memory storage devices.

With reference to FIG. 12, an exemplary system 200 for use in performing the above-described methods includes a general purpose computing device in the form of a computer 210. Components of computer 210 may include, but are not limited to, a processing unit 220, a system memory 230, and a system bus 221 that couples various system components including the system memory to the processing unit 220. The processing unit 220 may for example be an Intel Dual Core 4.3 G CPU with 8 GB memory. This is one of many possible examples of processing unit 220. The system bus 221 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 210 typically includes a variety of computer readable media. Computer readable media can be any available media that can be accessed by computer 210 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVDs) or other optical disk storage, magnetic cassettes, magnetic tapes, magnetic disk storage or other magnetic storage devices, or any other medium which can be used to store the desired information and which can be accessed by computer 210. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above are also included within the scope of computer readable media.

The system memory 230 includes computer storage media in the form of volatile and/or nonvolatile memory such as read only memory (ROM) 231 and random access memory (RAM) 232. A basic input/output system (BIOS) 233, containing the basic routines that help to transfer information between elements within computer 210, such as during start-up, is typically stored in ROM 231. RAM 232 typically contains data and/or program modules that are immediately accessible to and/or presently being operated on by processing unit 220. By way of example, and not limitation, FIG. 12 illustrates operating system 234, application programs 235, other program modules 236, and program data 237.

The computer 210 may also include other removable/non-removable, volatile/nonvolatile computer storage media. By way of example only, FIG. 12 illustrates a hard disk drive 241 that reads from or writes to non-removable, nonvolatile magnetic media, a magnetic disk drive 251 that reads from or writes to a removable, nonvolatile magnetic disk 252, and an optical disk drive 255 that reads from or writes to a removable, nonvolatile optical disk 256 such as a CD-ROM or other optical media. Other removable/non-removable, volatile/nonvolatile computer storage media that can be used in the exemplary operating environment include, but are not limited to, magnetic tape cassettes, flash memory cards, DVDs, digital video tape, solid state RAM, solid state ROM, and the like. The hard disk drive 241 is typically connected to the system bus 221 through a non-removable memory interface such as interface 240, and magnetic disk drive 251 and optical disk drive 255 are typically connected to the system bus 221 by a removable memory interface, such as interface 250.

The drives and their associated computer storage media discussed above and illustrated in FIG. 12 provide storage of computer readable instructions, data structures, program modules and other data for the computer 210. In FIG. 12, for example, hard disk drive 241 is illustrated as storing operating system 244, application programs 245, other program modules 246, and program data 247. These components can either be the same as or different from operating system 234, application programs 235, other program modules 236, and program data 237. Operating system 244, application programs 245, other program modules 246, and program data 247 are given different numbers here to illustrate that, at a minimum, they are different copies.

A user may enter commands and information into the computer 210 through input devices such as a keyboard 262 and pointing device 261, commonly referred to as a mouse, trackball or touch pad. Other input devices (not shown) may be included. These and other input devices are often connected to the processing unit 220 through a user input interface 260 that is coupled to the system bus 221, but may be connected by other interface and bus structures, such as a parallel port, game port or a universal serial bus (USB). A monitor 291 or other type of display device is also connected to the system bus 221 via an interface, such as a video interface 290. In addition to the monitor 291, computers may also include other peripheral output devices such as speakers 297 and printer 296, which may be connected through an output peripheral interface 295.

As indicated above, the computer 210 may operate in a networked environment using logical connections to one or more remote computers in the cluster, such as a remote computer 280. The remote computer 280 may be a personal computer, a server, a router, a network PC, a peer device or other common network node, and typically includes many or all of the elements described above relative to the computer 210, although only a memory storage device 281 has been illustrated in FIG. 12. The logical connections depicted in FIG. 12 include a local area network (LAN) 271 and a wide area network (WAN) 273, but may also include other networks. Such networking environments are commonplace in offices, enterprise-wide computer networks, intranets and the Internet.

When used in a LAN networking environment, the computer 210 is connected to the LAN 271 through a network interface or adapter 270. When used in a WAN networking environment, the computer 210 typically includes a modem 272 or other means for establishing communication over the WAN 273, such as the Internet. The modem 272, which may be internal or external, may be connected to the system bus 221 via the user input interface 260, or other appropriate mechanism. In a networked environment, program modules depicted relative to the computer 210, or portions thereof, may be stored in the remote memory storage device. By way of example, and not limitation, FIG. 12 illustrates remote application programs 285 as residing on memory device 281. It will be appreciated that the network connections shown are exemplary and other means of establishing a communications link between the computers may be used.

The foregoing detailed description of the inventive system has been presented for purposes of illustration and description. It is not intended to be exhaustive or to limit the inventive system to the precise form disclosed. Many modifications and variations are possible in light of the above teaching. The described embodiments were chosen in order to best explain the principles of the inventive system and its practical application to thereby enable others skilled in the art to best utilize the inventive system in various embodiments and with various modifications as are suited to the particular use contemplated. It is intended that the scope of the inventive system be defined by the claims appended hereto.

We claim:

1. A method for transforming search results for a search performed by a search engine, the method comprising the steps of:
(a) logging a search query, search results in a ranked position order and click through counts for the search results in a storage location;
(b) determining a goodness value for each stored search result for the query, the goodness value for each search result representing a relevance of the search result to the query;
(c) determining a position bias for each search result position for the query based in part on the particular query;
(d) transforming the search results by reordering the ranked position of the results based on a probability that a particular search result will be clicked on, the probability based on a product of the goodness value determined in said step (b) and the position bias determined in said step (c); and
(e) displaying the search results in the reordered ranked positions determined in said step (d) upon a next entry of the query.

2. The method of claim 1, wherein said step (b) of determining a goodness value for a search result comprises the step of determining a probability that the search result will be clicked on if positioned in the highest ranked position.

3. The method of claim 2, wherein said step of determining a probability that the search result will be clicked on if positioned in the highest ranked position comprises the step of examining all stored instances of the query and that search result.

4. The method of claim 1, wherein said step (c) of determining a position bias for a search result position comprises the step of determining a ratio of the probability that a search result at a given ranked position is clicked to the probability of that search result being clicked if positioned in the highest ranked position.

5. The method of claim 4, further comprising the step of determining whether the query is a navigational query or an informational query based on the determined position bias values for search results of the query.

6. The method of claim 1, wherein the determinations made in said steps (b) and (c) comprise the step of solving for the values of g(d) and p(j) in a system of equations in the form of c(d, j)=g(d)p(j), where c(d, j) is the probability that, for stored instances of the same query, a document d in a position j was clicked, g(d) is the goodness value of a document d, and p(j) is a position bias of a ranked position j.

7. The method of claim 6, wherein the number of variables in the system of equations is the sum of the number of distinct documents d and the sum of distinct positions j logged in the storage location for all instances of the same query, and the number of equations is equal to the number of search results logged in the storage location for all instances of the same query.

8. The method of claim 7, wherein, in the event the system is over-constrained by virtue of the equations outnumbering the variables, the equations are solved by minimizing the solution error using an error minimization norm.

9. The method of claim 1, further comprising the step of inferring the goodness values g(d) of documents which were not clicked on for the query q by considering additional search queries that are related to the search query for which the documents were clicked on.

10. The method of claim 9, wherein an additional search query is related to the search query if the additional search query shares a predetermined number of search results with the search query.

11. A method for transforming search results for a search performed by a search engine, the method comprising the steps of:
(a) logging a search query, search results in a ranked position order and click through counts for the search results in a storage location;
(b) transforming the ranking of the search results for the query by the step of determining a probability, c(d, j), that a search result document d at a position j in the ranked position order for the query will be clicked on by solving a system of equations c(d, j)=g(d)p(j), where g(d) is a goodness value based on a probability that the search result document d will be clicked on if positioned in the highest ranked position for the query, and p(j) is a position bias based on a ratio of the probability that a search result at a given ranked position j is clicked to the probability of that search result being clicked if positioned in the highest ranked position, wherein position bias may vary from query to query, and wherein the system of equations is obtained from the stored instances of the search results for the query; and
(c) displaying the search results in the reordered ranked positions determined in said step (b) upon a next entry of the query.

12. The method of claim 11, wherein the number of variables in the system of equations is the sum of the number of distinct documents d and the sum of distinct positions j logged in the storage location for all instances of the same query, and the number of equations is equal to the number of search results logged in the storage location for all instances of the same query.

13. The method of claim 11, wherein, if modeled on a bipartite graph having the documents d as vertices on a first side, the positions j as vertices on the second side, and edges between a pair of vertices (d, j) representing a search result document d for the query that has appeared in the ranked position order j, the values for g(d) and p(j) may be deduced if all documents are connected to all positions, directly or indirectly, via an edge.

14. The method of claim 11, wherein, if modeled on a bipartite graph having the documents d as vertices on a first side, the positions j as vertices on the second side, and an edge between a pair of vertices (d, j) representing that a search result document d for the query has appeared in the ranked position order j, the values for g(d) and p(j) may be deduced if all documents are connected to all positions, directly or indirectly, via an edge.

15. The method of claim 14, wherein, if the bipartite graph includes one or more disconnected components, the values of g(d) from different components may be compared based on determining a parameterized curve that approximates all position bias curves resulting from the distinct components, estimating a probability that a search result will be clicked based on the parameterized curve and measuring the click through rate for the different positions j, giving equal weight to each document.

16. The method of claim 11, further comprising the step of determining whether the query is a navigational query or an informational query based on the determined position bias values p(j) for search results of the query.

17. A computer storage medium having computer-executable instructions for programming a processor to perform a method of transforming search results for a search performed by a search engine, the method comprising the steps of:
(a) logging a search query, search results in a ranked position order and click through counts for the search results in a storage location;
(b) determining goodness values, g(d), for each stored search result document d for the query, the goodness value for each search result representing a relevance of the search result to the query;
(c) determining a position bias, p(j), for each search result position j for the query based in part on the particular query, position bias for a search result position being a ratio of the probability that a search result at a given ranked position j is clicked to the probability of that search result being clicked if positioned in the highest ranked position, said steps (b) and (c) being performed by solving for the values of g(d) and p(j) using a system of equations in the form of c(d, j)=g(d)p(j), where c(d, j) is the probability that, for stored instances of the same query, a document d in a position j was clicked;
(d) transforming the search results by reordering the ranked position of the results based on a probability that a particular search result will be clicked on based on said step (c); and
(e) displaying the search results in the reordered ranked positions determined in said step (d) upon a next entry of the query.

18. The method of claim 17, further comprising the step of determining whether the query is a navigational query or an informational query based on the determined position bias values p(j) for search results of the query.

19. The method of claim 17, further comprising the step of inferring the goodness values g(d) of documents which were not clicked on for the query q by considering additional search queries that are related to the search query for which the documents were clicked on.

20. The method of claim 19, wherein an additional search query is related to the search query if the additional search query shares a predetermined number of search result documents d with the search query.
